(19) United States
(12) Patent Application Publication
(10) Pub. No.: US 2006/0285653 A1
(43) Pub. Date: Dec. 21, 2006

(54) Method for downloading a melody on a switched telephone network

(76) Inventor: Philippe Leloup, Paris (FR)

Correspondence Address: LOWE HAUPTMAN BERNER, LLP, 1700 DIAGONAL ROAD, SUITE 300, ALEXANDRIA, VA, 22314, US

(21) Appl. No.: 10/546,258

(22) PCT Filed: Jan. 23, 2004
(86) PCT No.: PCT/FR04/00148

§ 371 Date: Jul. 27, 2006

(51) Int. Cl. H04M 1/64

(52) U.S. Cl. 379/67.1

(57) ABSTRACT

A method for downloading a melody on an RTC network DECT-type terminals, using at least one melody sever (2) connected to the RTC network. Said method consists of a connection (51) between the melody server (2) and a telephone terminal (1) linked to the RTC network; preparation of the terminal (1) upon reception of an audio signal by sending parameters, which are characteristic of the melody, according to a digital communication protocol from the server (2); switching inside the terminal (1), which is programmed during preparation, in order to switch to an analog communication mode; transmission (55) of an analog signal representing a polyphonic melody from the server to the telephone terminal (1); storing data which is representative or the signal transmitted by the server (2).

### TECHNICAL FIELD OF THE INVENTION

The present invention relates to the field of digital wireless communications over the switched telephone network (STN) and more particularly to a method for downloading a melody for terminals conforming to a DECT type protocol.

Customization of one DECT telephone terminal by downloading from a dedicated server may presently be performed according to a digital message exchange protocol such as for example SMS (Short Message Service) according to the ETSI ES 201 912 standard, by means of a modem with a bit rate limited to 1,200 bits/s. Classical melodies generally hardly require more than 400 bytes, i.e., a maximum of 3 SMS messages of 160 bytes. This generates for the user, a maximum cost of the order of 45 euro cents which is acceptable. On the other hand, polyphonic melodies are significantly more elaborated and require about 4 kbytes per second of melody. This type of melody may indeed contain for example 16 notes played with 12 different instruments, simultaneously. To receive a polyphonic melody on a DECT telephone terminal having, for terminal cost reduction reasons, a modem with a low bit rate, for example of the order of 1,200 bits/s, tens of SMS messages would have to be sent for each second of melody. This would generate for the user a cost of the order of 1.5 euros per second of melody, i.e., for a normal melody (10 seconds) a cost of 15 euros, which is unacceptable.

Of course, DECT telephone terminals may therefore allow the downloading of classical melodies via one to three SMSs, but they do not allow the downloading of a polyphonic melody at a reasonable cost.

### TECHNOLOGICAL BACKGROUND OF THE INVENTION

It is known from the prior art, by document US 2002/0013154, in the name of A. BYEUNG YUN SOH et al., published on Jan. 31^{st} 2002, how to use the short message service SMS in order to be able to generate downloading of sounds or images towards mobile telephones, according to an exclusively digital transmission mode. Such method requires the use of a modem with a high bit rate.

A method is also known, by document JP 2000 134 332, in the name of A. KATSUYA et al., published on May 12^{th} 2000, for downloading a melody which uses the transmission of messages, from a central server towards a similar portable telephone. However, the transmission remains digital and preferentially requires a modem with a bit rate larger than 1,200 bits/s in order to remain within acceptable costs for polyphonic melodies.

Presently, there is no known solution other than SMS for DECT terminals. On mobile terminals, such melodies may be downloaded via a WAP protocol with bit rates between 9,600 bits/s and 40 kbits/s. On the STN network, polyphonic melodies are also downloadable via Internet by means of a standard V90 or V34 modem with a bit rate of 56 kbits/s. On the other hand, manufacturing DECT telephones provided with a high bit rate modem cannot be contemplated without an impedimental increase in the cost of this type of devices.

### GENERAL DESCRIPTION OF THE INVENTION

The object of the present invention is therefore to suppress one or more drawbacks of the prior art by defining a method for downloading a melody, suitable for DECT type terminals.

For this purpose, the invention relates to a method for downloading a melody over the switched telephone network STN for terminals fitted out with low bit rate modems (for example of the DECT type), by applying at least one melody server connected to the STN network, characterized in that it includes:
a connection step between the melody server and a telephone terminal connected to the STN network,
a step for preparing the terminal to receive an audio signal, by sending via a digital communication protocol from the server, characteristic parameters of the melody,
a step for switching the terminal, programmed at the time of said preparation step, during which the digital communication protocol of the modem switches to an analog communication mode with the STN network,
a step for transmitting from the server an analog signal representative of a melody, towards said telephone terminal,
a step for storing in a memory available to the telephone terminal, data, representative of the signal transmitted by the server.

According to another feature of the invention, said analog signal is representative of a polyphonic melody.

According to another feature of the invention, the digital communication between terminal and server are performed according to a half duplex digital transmission protocol (for example of the SMS type).

According to another feature of the invention, before the storage step, the analog signal is transformed into digital data by a CODEC of the terminal.

According to another feature of the invention, the terminal again switches to the digital communication mode with the server, after receiving and storing data representative of the signal transmitted by the server, and notifies to the latter the end of reception of the signal.

According to another feature of the invention, the server issues a disconnection order to the terminal after the sending by the latter of an acknowledgment of receipt of the analog signal.

According to another feature of the invention, at least one melody issued from the server is selected by a user from a means for accessing the melody server by selecting with browsing means of this access means at least one parameter identifying said melody proposed in a menu of melodies.

According to another feature, said means for accessing the server is the DECT type telephone terminal.

According to another feature, the connection is carried out via a modem with a bit rate lower than or equal to 1,200 bits/s of the V23 or Bell type, of the telephone terminal.

According to another feature, the signal representative of the melody is transformed into digital data by a CODEC of the telephone terminal, said digital data then being compressed into a compacted format by compression means and subsequently stored in a memory of the terminal.

According to another feature, the step for transmitting the analog signal to the DECT type terminal is initiated by sending from said terminal a short SMS message including at least one piece of information about the selected melody.

According to another feature, the step for transmitting the analog signal to the DECT type terminal is initiated by the server, following reception by said server of at least one parameter for designating said melody and a parameter for identifying the DECT type terminal, sent from a third party terminal.

According to another feature, the server is directly called by the terminal by activating a number of the melody server, parameterized in said terminal.

According to another feature, the terminal transmits through a radio transmission channel, data, representative of the signal received from the server after digitization by the terminal, to a radiotelephone set associated with the terminal, said set storing these data in a memory.

According to another feature, the steps for connecting to the server and for transmitting the analog signal are activated via a melody downloading functionality of the DECT type terminal.

According to another feature, an order for the melody to be provided to a DECT type terminal is performed by said means for accessing the server, by sending to the server, data identifying the melody, the server then calling said terminal and downloading the ordered melody.

According to another feature, sound reproducing means of said terminal generate a sound corresponding to the melody from data representative of the signal transmitted by the server, stored in the telephone terminal.

Another object of the invention is to provide a solution to one or more of the problems encountered in the prior art, by defining a melody server computer system including functions analogous to a standard SMS server in order to provide polyphonic melodies according to the standardized SMS transmission protocol.

This object is achieved by a server computer system connected to the switched telephone network STN suitable for applying the method for downloading a melody, including first means for storing data representative of polyphonic melodies and second means for storing authorized numbers, characterized in that it includes:
means for identifying the caller exclusively establishing via the STN network, a connection exclusively with an authorized terminal,
first communications means providing an authorized terminal, according to the protocol for transmitting SMS type digital messages, with instructions and parameters relative to the downloading of the melody, issued from data stored in said first storage means,
second communications means providing the authorized terminal with an analog signal issued from data stored in said first storage means,
means for transmitting a switching signal for switching the authorized terminal from the digital communication protocol with a modem to an analog communication mode with the STN network,
means for identifying a melody from at least one identification parameter,
a program for managing the orders notably initiating the downloading of a melody to the terminal.

According to another feature, said first storage means comprise means for storing melodies in an analog form.

According to another feature, said first storage means comprise means for storing melodies in a digital form and a module for converting digital data into analog signals.

A last object of the invention is to propose a terminal allowing the application of the method and its use with the server computer system.

This object is achieved by a telephone terminal suitable for connecting to a switching network of the STN type and having at least one radio set for communicating with said terminal, suitable for application of the method, comprising means for receiving and transmitting digital messages through a modem with a bit rate less than or equal 1,200 bits/s and means for receiving audio analog signals, characterized in that it includes:
means for detecting a switching signal performing the switching of reception in a digital mode to reception in an analog mode for a determined period, the value of which has been stored beforehand in a memory or a counter, the determined period being set by the contents of a previously received digital message; and
means for switching back at the end of the determined period to the digital reception and transmission mode.

### SHORT DESCRIPTION OF THE DRAWINGS

The invention, with its features and advantages, will become more clearly apparent upon reading the description made with reference to the appended drawings given as non-limiting examples wherein:

FIG. 1 schematically illustrates a process for ordering and simultaneously receiving a melody, as allowed by the invention,

FIG. 2 illustrates a diagram of the local network connected to a melody provider server,

FIG. 3 illustrates as functional block diagrams, the base and a set of the local network which may be connected to the melody provider server,

FIG. 4 schematically illustrates a type of connection according to the invention in which the terminal used for ordering the melody and the terminal receiving the melody are different.

FIG. 5 schematically illustrates an exemplary process for ordering a melody through a terminal,

FIG. 6 schematically illustrates an exemplary process for sending a melody by a melody provider server.

### DESCRIPTION OF THE PREFERRED EMBODIMENTS OF THE INVENTION

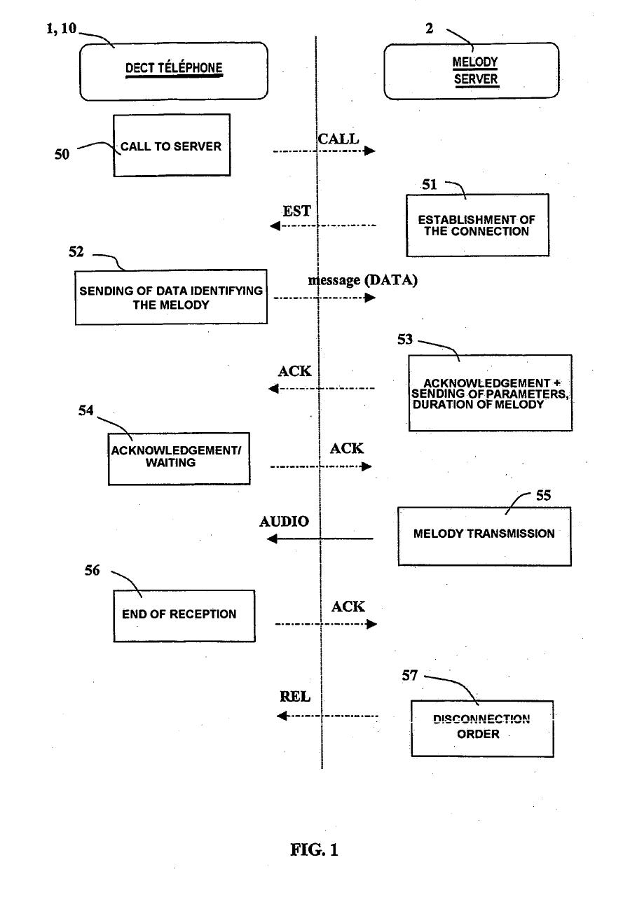

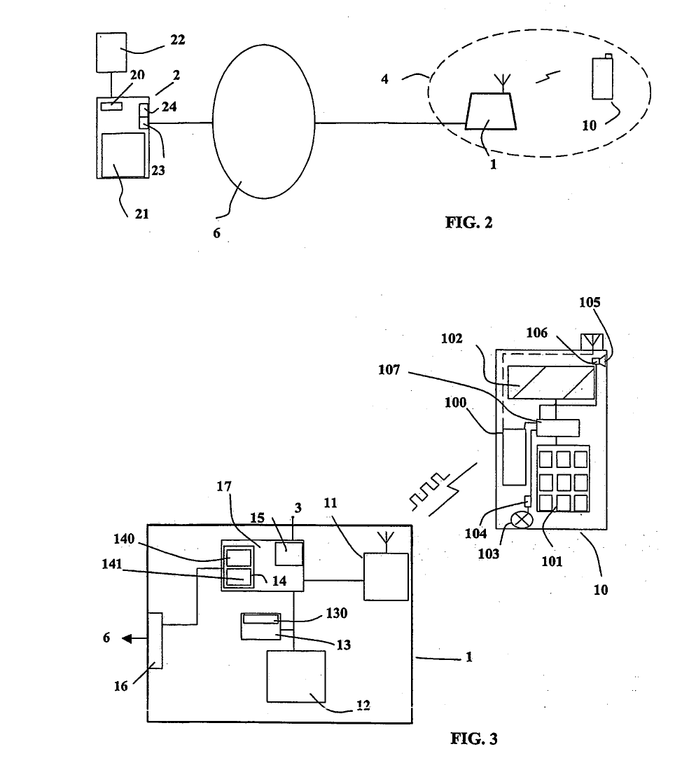

The invention will now be described in connection with FIGS. 1 and 2. The radio telephone local network (4), illustrated in FIG. 2, comprises a radio telephone base 1, for example of the DECT type or the like, or an associated radio telephone set (10) intended for communicating with the base (1) through a radio transmission channel. The base (1) is conventionally connected to the switched telephone network STN (6). In an embodiment of the invention, a melody provider or server computer system (2) is connected to the switched telephone network STN (6). This computer system includes first storage means (21) for storing data representative of melodies, second storage means (22) for storing authorized numbers for accessing the melodies, and a program for managing (20) the orders notably used for initiating a downloading of a melody. In an embodiment of the invention, polyphonic melodies are stored in the first storage means (21) of the server (2). This computer system includes for example means for identifying the caller for exclusively establishing a connection with an authorized terminal, i.e., the number of which is stored in said second storage means (22). These authorized numbers may of course be updated regularly.

As illustrated in FIG. 1, the method for downloading a melody according to the invention may be directly achieved between a telephone terminal (1) of the DECT type and the polyphonic melody server system (2). The downloading process notably involves a connection step (51) between the server (2) and the telephone terminal (1), a step for preparing the terminal (1) to receive an audio signal, a switching step programmed at the time of said preparation step for switching from the protocol for communicating through digital messages, for example of the SMS type, to the analog communication mode, and then a step for transmitting (55) from the server (2) an analog signal representative of a polyphonic melody towards said terminal (1). With a step for storing data representative of the signal transmitted by the server (2) in a memory available to the telephone terminal (1), the terminal may retain the downloaded melody. For example the terminal (1) and the server (2) are compatible with the ETSI ES 201 912 standard so as to notably allow transmission of characteristic parameters of melodies through SMS messages from the server (2). The server (2) of polyphonic melodies may therefore include the same functionalities as a standard SMS message provider server.

Subsequently, the use of the term message will refer to a message complying with a digital communication protocol of the SMS type or of another type.

The characteristic parameters of melodies notably allow the identification and duration of a melody to be indicated. At the time of step (53) when parameters allowing downloading of the melody are transmitted by the server (2) to the terminal (1), the server may also transmit to the terminal (1) an order used for preparing the terminal (1) to receive the melody in the suitable communications mode and to switch into this mode at the right moment. At the end of the transmission step (55), after a time interval substantially equal to the duration of the melody, the terminal (1) again switches to the mode of digital communication with the server (2) through messages and may notify the end of reception of the signal to the latter. During this time interval, data representative of the signal transmitted by the server (2) have been received and stored by the terminal (1).

In the embodiment of FIG. 1, the process according to the invention starts with a calling step (50) with a “CALL” message dialled from the DECT telephone terminal (1) to the server (2) providing the service for ordering a melody. The melody, for example a polyphonic melody, may be selected by the user by means of a short SMS message intended for the server (2) mentioning at least one melody identification parameter. Subsequently to the step for establishing the connection (51) by a message, commonly called “ESTABLISH”, the DECT terminal (1) sends in step (52) a message containing data identifying the melody selected by the user. The title or a specific number of the melody may be used as an identification parameter. The server (2) provides as a response (53), an acknowledgment message ACK which may indicate as a parameter, the duration of the polyphonic melody to be sampled. Parameters other than the duration may be contemplated in alternative embodiments. After the step (54) for transmitting the acknowledgment message “ACK” provided by the terminal (1) to notify to the server (2) proper receipt of the duration parameter, the server transmits in step (55), melody AUDIO vocal data transmitted as an analog signal through the STN network (6) to the terminal (1). The terminal (1) acknowledges receipt of the analog signal during the time indicated by the duration parameter and then notifies to the server (2) at the time of step (56), the end of the reception (56) of the melody signal by an acknowledgment message “ACK”. Finally, the server (2) indicates to the terminal (1) at the time of step (57), the end of the communication by a “RELEASE” message.

The invention will now be described in connection with FIGS. 3 to 6.

FIG. 3 shows a DECT type telephone device with its base (1) connected to the STN network (6) and an associated set (10) communicating with the Later via a small range and low power radio link, for example of the order of 300 meters. The base (1) conventionally comprises an interface (16) for connecting to the external telephone network, here the STN network (6), a central control unit (17), an electric power supply (3), a unit for radio transmission and reception (11), means for storing (13) configuration files, and a tree of menus each allowing a selection of operations and a user interface unit (12) which may comprise keys or a keyboard and optionally a graphic interface. The central control unit (17) achieves a controller function with a microprocessor or a microcontroller. This central unit also includes a DSP (Digital Signal Processing) portion (not shown). The radio transmission and reception unit (11) is laid out for transmitting and receiving data, through radio transmission channels conforming to the DECT protocol.

In the embodiment of FIG. 3, the user interface unit (12) is connected to means for storing (13) menus and may be laid out in order to control through radio transmission, the display of information, and notably of menus, on a screen (102) of the set (10). With this user interface unit (12), the commands inputted by a user by means of the set (10), may also be interpreted. In a known way, the set (10) includes a radio transmission/reception unit (100), a central control unit (107) and a man-machine interface. This man-machine interface of the set (10) comprises an input keyboard (101), a display screen (102), a microphone (103) and a loudspeaker (105). The microphone (103) and the loudspeaker (105) are respectively connected to an analog/digital converter ADC (104) and to a digital/analog converter DAC (106) for respectively converting the analog signals received by the microphone or emitted by the loud speaker, into digital signals for the radio unit (100).

In an embodiment of the invention, the server (2) may be directly called from the set (10) by dialling a number of the polyphonic melody server (2), this number being parameterized in one of the menus stored in the storage means (13). Thus, the steps for connecting (51) to the server (2) and for transmitting (55) the analog signal are for example activated via a melody downloading functionality, the program of which is stored in the DECT type telephone terminal. The input keyboard (101) of the set (10) may conventionally comprise standard telephone keys, a key for controlling the display of a main menu and keys for browsing in the tree of the menus, in order to notably access this melody downloading functionality.

The central control unit (107) comprises for example a microprocessor, to which all the components of the set (10) are connected, and is laid out for controlling the operation of the set (10). In an alternative, the use of a microcontroller to replace the microprocessor may be contemplated.

Here, one insists on the absence of any fast link modem (for example 56 kbits/s), the set (10) being a conventional DECT set, lacking Internet capabilities. The base (1) is provided with a modem (140) of the V23 type, the rate of which is limited to 1,200 bits/s. This modem (140) enables a connection with a conventional SMS server to be established and SMSes to be received. Advantageously in the invention, with this modem (140), exchanges between the base (1) and the polyphonic melody server (2) may be directly performed according to the SMS short message transmission protocol, as defined by standard ETSI ES 201 912. The V23 modem (140) also provides a caller identifying function designated as “CLIP” (Calling Line Identification Presentation) in order to recognize the caller number.

In an alternative embodiment of the invention, the terminal (1) transmits through a radio transmission channel, digitized data, representative of the analog signal corresponding to a melody, to a radiotelephone set (10) associated with the terminal (1), said set (10) storing these data either in an erasable memory or not (not shown).

In an embodiment of the invention, the interface (16) for connecting to the STN network (6) of the base (1) is connected to a connection unit (14) incorporating the V23 type modem (140) and a coder-decoder circuit or CODEC (141), for example of the AUDIO DECT type, used for digitizing incoming data. A DTMF (Dual Tone Multifrequency Signalling) module (15) for detecting the tone also receives signals from the connection unit in order to notably detect among other functions, the signal for controlling the switching from the digital reception mode to the analog reception mode.

In an embodiment of the invention, the microcontroller of the central control unit (17) of the base (1) includes a module allowing identification and transmission by the modem (140) of the caller number between two trains of rings. It is thereby possible to recognize a call coming from the melody server (2) and to automatically establish communication by SMS type messages.

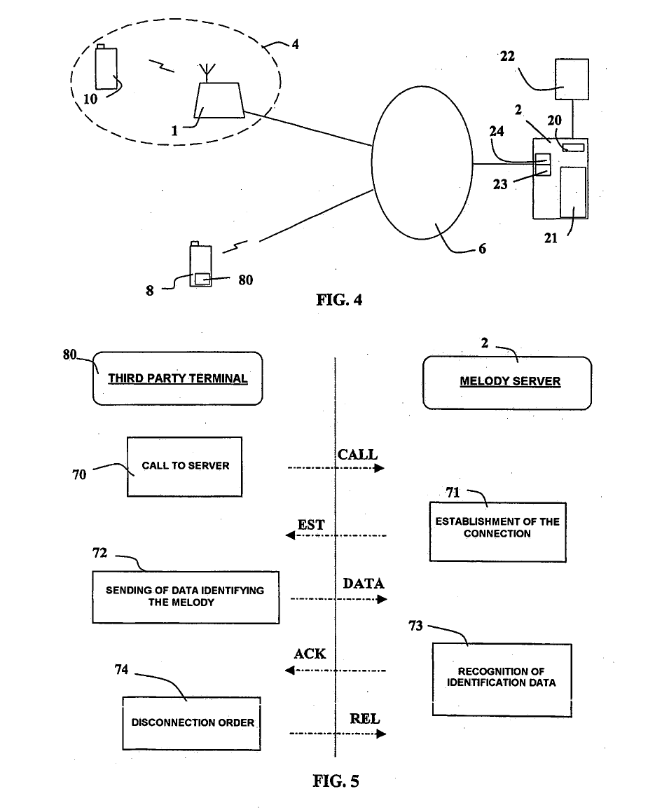

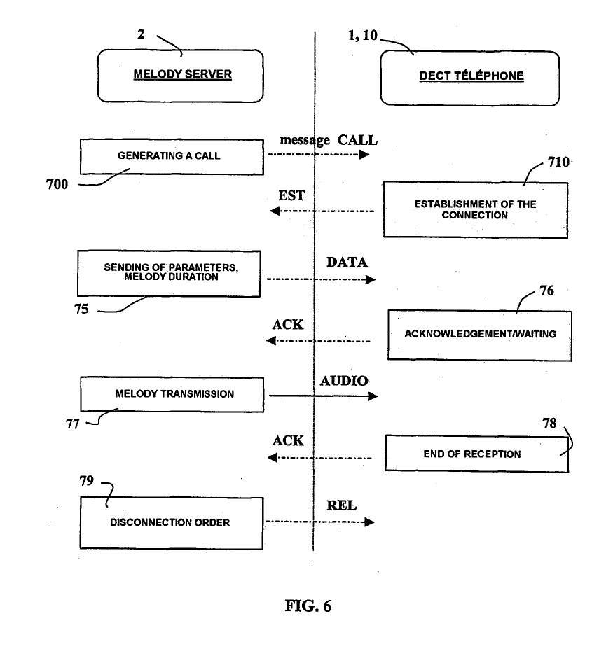

FIGS. 4 and 5 illustrate the possibility allowed by the invention, of ordering a melody for example a polyphonic melody, by a third party terminal (8). This third party terminal (8) is formed by a means for accessing the polyphonic melody server (2), for example a computer connected to the STN network via Internet, a mobile or fixed telephone, or any other compatible access means with sending of data by SMS messages according to the standard ETSI ES 201 912. A polyphonic melody stored in the first storage means (21) of the server (2) may be selected from a menu of melodies by a user from this third party terminal (8) by selecting with browsing means of this third party terminal (8) cooperating with a program module (80), a parameter for designating the selected polyphonic melody. With the browsing means of this third party terminal (8) it is possible to add to this designation parameter, a parameter for identifying the DECT type telephone for which the melody is intended. It may be quite simply the call number of the DECT type telephone. In the example of FIG. 5, a user uses the third party terminal (8) for ordering the melody, by calling the server (2) in step (70). Following the step (71) for establishing the connection by an “ESTABLISH” message from the server (2), the parameters for designating the polyphonic melody and identifying the DECT type telephone, inputted by the user beforehand, are sent to the next step (72) in an SMS type message to the server (2). The latter provides in step (73) an acknowledgment message “ACK” and the program module (80) of the third party terminal (8) may transmit in step (74) the disconnection order by a “RELEASE” message.

The program for managing (20) the orders from the server (2) may now use subsequently the parameters provided at the time of the order for sending the polyphonic melody extracted from the first storage means (21) according to the selection of the user at the DECT type terminal (1), designated by its call number for which the melody is intended. As illustrated in FIG. 6, the step for transmitting the analog signal representative of the melody towards the base (1) of the DECT type terminal is initiated by the server (2), which generates a call (700) to the base (1). At the step (710) for establishing the connection by the “ESTABLISH” message notified by the base (1), the polyphonic melody server (2) provides (75) in the digital message exchange protocol, one or more parameters, notably characteristic of the polyphonic melody to be downloaded, for example the title and a datum representative of the duration of the melody or other relevant parameters for identifying and sampling the melody. After the acknowledgement “ACK” message is sent in step (76) by the base (1), the terminal (1) waits for reception and the ordered polyphonic melody is sent (77) by the server (2) as an analog signal over the telephone line. The end-of-reception steps (78) and those for sending a disconnection order or RELEASE (79) complete the process.

Upon sending (77) the analog signal corresponding to the polyphonic melody, the server (2) transmits a start signal of the melody called START in order to trigger, following detection of this signal by the DTMF module (15) of the base (1), a switching in the connection unit (14) from the V23 type modem (140) reception to reception by the CODEC circuit (141), this switching being substantially performed when the “START” is transmitted. This “START” signal may for example be detected via a DTMF tone. In an alternative, the switching order may be initiated by the server (2) at the time of step (75) during which the characteristic parameters of the melody are transmitted by a message to the terminal (1). With the duration parameter, stored in a memory or a counter, the base (1) may maintain reception of the signal by the CODEC (141) connected to the telephone line during a time interval just sufficient for acquiring the entirety of the melody. The analog signal of the polyphonic melody is transformed by the CODEC (141) into digital data in a compacted, for example ADPCM (Adaptive Delta Pulse Code Modulation) format, so as to be subsequently stored either in an erasable memory 130) or not of the base (1), for example a FLASH type memory or another memory incorporated into the storage means (13) of the base (1). Compaction of the digitized data may be carried out by an intermediate compression unit (not shown). The data representative of the polyphonic melody transmitted by the server (2), thereby stored in the base (1) of the telephone terminal, may be used by sound reproduction means of the terminal to generate a sound corresponding to the polyphonic melody or transmitted through the half-duplex radio link to the radiotelephone set (10).

In an embodiment of the invention, and in a non-limiting way, the user who wishes to order a polyphonic melody at the server (2) must call a paid access number. Invoicing for the download may then be simply carried out by this call. As mentioned above, the user has the possibility of calling the server from the DECT type terminal in order to order and receive the polyphonic melody of his/her selection simultaneously or of performing this call from a third party terminal (8) for ordering a melody.

It will be understood that the melody server computer system (2) used in the invention includes first communication means (23), for example compatible with the ETSI ES 201 912 standard, for providing an authorized terminal, according to the SMS type message transmission protocol, with instructions and parameters relative to the downloading of the melody and second communications means (24) for providing the authorized terminal with an analog signal issued from data stored in said first storage means (21).

The computer system further comprises means (not shown) for transmitting a switching signal in order to switch the authorized terminal from the digital communication protocol with a modem (140) to an analog communication mode with the STN network (6). In an alternative, a switching signal may also be sent for triggering the reverse switching, the time required for receiving the melody being for example determined between switching signals coming from the server (2). It is equipped with the CLIP function. This computer system also includes means for identifying a polyphonic melody from at least one identification parameter which may be sent from a terminal. Updating of the authorized numbers the second storage means (22) may be performed at regular intervals, each of the authorized numbers having been stored in response to an order for downloading a polyphonic melody. The first storage means (21) may comprise means for storing melodies in an analog form or in a digital form or in a combination of both. A module for converting digital data into analog signals may be integrated or associated with these first storage means (21).

In an embodiment of the invention, both types of protocols may be contemplated for transmitting the polyphonic melody by SMS towards the base (1) of the DECT type terminal. These protocols are preferably protocols 1 and 2 from the ETSI ES 201 912 standard. In an alternative embodiment, the microcontroller of the central control unit (17) may comprise means for adapting to both of these protocols, one of these two protocols being chosen by selecting a configuration parameter.

The invention may of course be applied to any type of radiotelephone local network other than DECT.

One of the advantages of the invention lies in the possibility of downloading polyphonic melodies for a reasonable cost, without any major change made to conventional DECT type terminals.

Another of the advantages of the invention lies in the taking into account of different possibilities for ordering a polyphonic melody for the user.

It should be apparent to persons skilled in the art that the present invention allows embodiments under many other specific forms without departing from the field of application of the invention as claimed. Consequently, the present embodiment would be considered by way of illustration, but may be changed in the field defined by the scope of the appended claims, and the invention should not be limited to the details given above.

1. A method for downloading a melody over a switched telephone network STN for terminals equipped with low bit rate modems, applying at least one melody server connected to the STN network, comprising:
a connection step between the melody server and a telephone terminal connected to the STN network;
a step for preparing the telephone terminal to receive an audio signal, by sending according to a digital communication protocol from the server, characteristic parameters of the melody;
a step for switching the telephone terminal, programmed at the time of said preparation step, during which the digital communication protocol of the modem switches to an analog communication mode with the STN network;
a step for transmitting from the server, an analog signal representative of a melody, to said telephone terminal; and
a step for storing in a memory available to the telephone terminal, data, representative of the signal transmitted by the server.

2. The method according to claim 1, wherein said analog signal is representative of a polyphonic melody.

3. The method according to claim 1, wherein the digital communication between the telephone terminal and the server are performed according to a half-duplex digital transmission protocol.

4. The method according to claim 1, wherein, before the storage steps, the analog signal is transformed into digital data by a CODEC of the telephone terminal.

5. The method according to claim 1, wherein the telephone terminal again switches to the digital communication mode with the server after receiving and storing data representative of the signal transmitted by the server, and notifies to the latter the end of reception of the signal.

6. The method according to claim 1, wherein the server gives a disconnection order to the telephone terminal after the sending by the latter of an acknowledgement of receipt of the analog signal.

7. The method according to claim 1, any of claim 1, wherein at least one melody issued from the server is selected by a user from a means for accessing the melody server by selecting with browsing means of this access means, at least one parameter identifying said melody proposed in a menu of melodies.

8. The method according to claim 7, wherein said means for accessing the server is the DECT type telephone terminal.

9. The method according to claim 1, wherein the connection is performed via a modem with a bit rate less than or equal to 1,200 bits/s, of the telephone terminal.

10. The method according to claim 1, wherein the signal, representative of the melody, is transformed into digital data by a CODEC of the telephone terminals, said digital data being then compressed into a format compacted by compression means and subsequently stored in a memory of the telephone terminal.

11. The method according to claim 8, wherein the step for transmitting the analog signal to the DECT type terminal is initiated by the sending from the telephone said terminal of a short SMS message including at least one piece of information on the selected melody.

12. The method according to claim 8, wherein the step for transmitting the analog signal to the DECT type terminal is initiated by the, consecutively to reception by said server of at least one parameter designating said melody and a parameter for identifying the DECT type terminal, sent from a third party terminal.

13. The method according to claim 1, wherein the server is directly called by the telephone terminal by activating a number of the melody server parameterized in the telephone terminal.

14. The method according to claim 1, wherein the telephone terminal transmits through a radio transmission channel, data representative of the signal received from the server after digitization by the telephone terminal, to a radiotelephone set associated with the telephone terminal, said set storing these data in a memory.

15. The method according to claim 8, wherein the steps for connecting to the server and for transmitting the analog signal are activated via a melody downloading functionality of the DECT type terminal.

16. The method according to claim 7, wherein an order for a melody to be provided to a DECT type terminal is performed by said means for accessing the server, by sending to the server, data for identifying the melody, the server then calling the telephone terminal and downloading the ordered melody.

17. The method according to claim 1, wherein sound reproducing means of the telephone terminal generate sound corresponding to the melody from data representative of the signal transmitted by the server, stored in the telephone terminal.

18. A server computer system connected to the switched telephone network STN adapted for application to the melody downloading method according to claim 1, including first means for storing data representative of melodies and second means for storing authorized numbers, comprising:
caller identification means exclusively establishing via the STN network, a connection with an authorized terminal;
first communications means providing an authorized terminal, according to the SMS type digital message transmission protocol, with instructions and parameters relative to the downloading of the melody, from data stored in said first storage means;
second communications means providing the authorized terminal with an analog signal from data stored in said first storage means;
means for transmitting a switching signal, switching the authorized terminal from the digital communication protocol with a modem to an analog communication mode with the STN network;
means for identifying a melody from at least one identification parameter; and
a program for managing orders notably initiating the downloading of a melody to a terminal.

19. The server computer system according to claim 18, wherein said first storage means comprise means for storing melodies in an analog form.

20. The server computer system according to claim 18, wherein said first storage means comprise means for storing melodies in a digital form and a module for converting digital data into analog signals.

21. A telephone terminal adapted for connection to a switched network of the STN type and having at least one radio set for communicating with said terminal, adapted for application of the method according to claim 1, comprising means for receiving and transmitting digital messages by a modem with a bit rate less than or equal to 1,200 bits/s and means for receiving audio analog signals, comprising:
means for detecting a switching signal performing the switching from reception in a digital mode to reception in an analog mode during a determined period, the value of which having been stored beforehand in a memory or a counter, the determined period being set by the contents of a digital message received beforehand; and
means for switching back to the digital reception and transmission mode at the end of the determined period.
